(19) United States
(12) Patent Application Publication
(10) Pub. No.: US 2008/0114879 A1
(43) Pub. Date: May 15, 2008

(54) DEPLOYMENT OF CONFIGURATION DATA WITHIN A SERVER FARM

(75) Inventors: Corey M. Roussel, Redmond, WA (US); John Keith Bankston, Bothell, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/746,317

(22) Filed: May 9, 2007

Related U.S. Application Data
(60) Provisional application No. 60/859,026, filed on Nov. 14, 2006.

(51) Int. Cl. G06F 15/173

(52) U.S. Cl. 709/226

(57) ABSTRACT

Deployment of configuration information within a server farm may be provided. Often one or more servers are connected to increase processing and storage capabilities for providing content to a website and receiving content from the website. Accordingly, coordination must occur between the connected servers in order to accurately manage website content. This coordination may ensure that each of the servers contain identical configuration information in order to prevent operational limitations on any of the servers. By having identical configuration information on each of the servers, any of the servers may complete a required task for managing website content. Automating configuration information installation provides an efficient and accurate process to prevent web content errors due to different configuration information running on one or more servers when website content is accessed.

### BACKGROUND

Deployment of configuration information within a server farm is an automated process for incorporating and configuring additional servers in the server farm or updating configuration information in the server farm. In some situations, data traffic for a website can overcome data storage capacity or processing capacity for a single web server. Accordingly, additional servers may be connected to the single web server creating a server farm to provide additional data storage and processing capacity. The conventional strategy relies upon manual coordination of configuring and updating servers within the server farm or added to the server farm. However, this manual coordination of servers is tedious and often leads to web page errors because the configuration information or update information may not have been incorporated into all of the servers within the server farm. In addition, such issues are compounded when the server farms contain a vast number of servers.

It is with respect to these and other considerations that the present invention has been made.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Deployment of configuration information within a server farm may be provided. Often one or more servers are connected to increase processing and storage capabilities for providing content and services to a website and for receiving content from the website. Accordingly, coordination must occur between the connected servers in order to accurately manage website content. This coordination may ensure that each contains identical configuration information in order to prevent operational limitations for handling web content or services by any of the servers. By having identical configuration information on each of the servers, any of the servers may complete a required task for managing services and content for a website. Automating configuration information installation provides an efficient and accurate process to prevent web content errors due to different configuration information running on one or more servers.

In accordance with one embodiment, a method is provided for deploying configuration information within a server farm by associating a first server with a data storage component. Upon associating the first server with the data storage component, the method stores configuration information associated with the first server at the data storage element. The method associates one or more servers with the first server and the data storage component. The method also automatically configures the one or more servers using the configuration information stored at the data storage component thereby sharing computing capabilities between the first server and the one or more servers.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 illustrates a networked operating environment where embodiments may be practiced;

FIG. 2 is a flow chart of a method for deploying configuration information within a server farm;

FIG. 3 is a flow chart of another method for deploying configuration information within a server farm:

FIG. 4 is a screen shot of an example of a user interface where embodiments of the invention may be practiced; and

FIG. 5 is a block diagram of a system including a computing device for use in the networked operating environment of FIG. 1.

### DETAILED DESCRIPTION

The following detailed description refers to the accompanying drawings. Wherever possible, the same reference numbers are used in the drawings and the following description to refer to the same or similar elements While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Deployment of configuration information within a server farm may be provided. Consistent with embodiments of the present invention, a method and system for deploying configuration information within a server farm is disclosed. Often data traffic for a web server hosting a website may overcome the capacity of the web server causing delays in providing web content or a complete failure in providing the web content to viewers. Accordingly, additional web servers may be connected to each other to create a server farm in order to increase capacity and processing capabilities. However, connecting a new web server to the server farm, or updating servers within the server farm manually may be problematic because during each addition or update, software and configuration information may be loaded incorrectly or may fail to be loaded altogether causing problems when interacting with the website. Accordingly, an embodiment of the invention may provide a user with a method for deploying configuration information within a server farm in an automated fashion.

An embodiment consistent with the invention may include a system for deploying configuration information within a server farm. The system may comprise a memory storage and a processing unit coupled to the memory storage. The processing unit may be operative to associate a plurality of servers with a memory storage. Upon associating the plurality of servers with the memory storage, the processing unit may also store configuration information associated with the plurality of servers in the memory storage. The processing unit may receive configuration information changes associated with at least one server of the plurality of servers. The processing unit may update the memory storage with the changed configuration information. The processing unit may automatically update the plurality of servers with the changed configuration information.

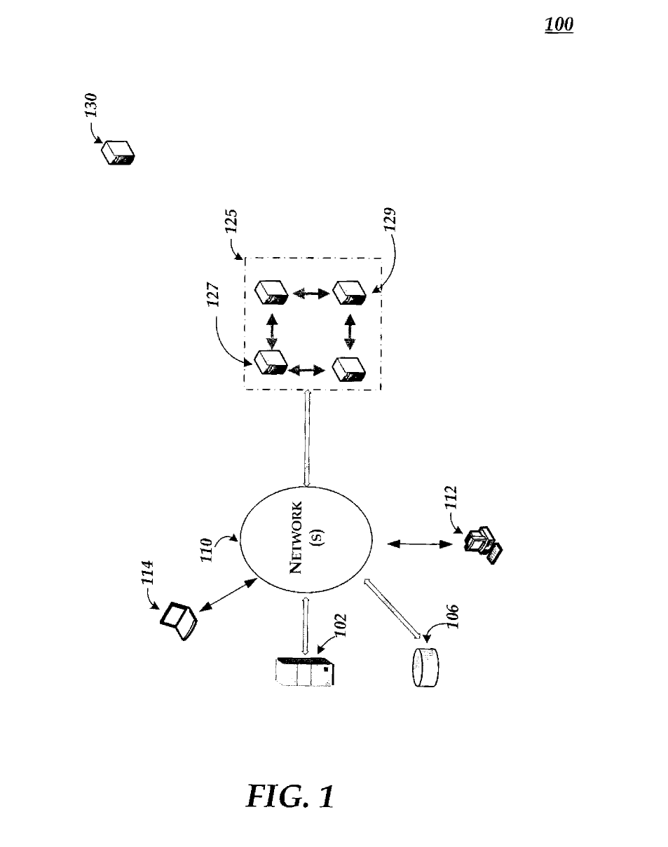

Referring to FIG. 1, a server farm management system 100 is illustrated where example embodiments may be implemented. The server farm management system 100 may include a computer network 110, a server 102 which manages a database 106, a desktop computer 112, a laptop computer 114, a server farm 125 that includes one or more servers, for example, web server 127 and web server 129, and a new web server 130.

Server farm management system 100 may transmit and receive data to and from computing devices such as the server 102, the desktop computer 112, the laptop computer 114, and the server farm 125 using the computer network 110. The server farm 125 may be used to maintain and provision content and web services for one or more web sites and manage data traffic for the one or more web sites. Furthermore, the server farm management system 100 may transmit or receive data to a storage system 106, which is managed by server 102 using the computer network 110. Other computing devices may also participate in the server farm management system 100. The computer network 110 may include a secure network such as an enterprise network, or an unsecure network such as a wireless open network. By way of example, and not limitation, the computer network 110 may include wired media such as a wired network or direct-wired connection, and wireless media such as acoustic, RF, infrared and other wireless media.

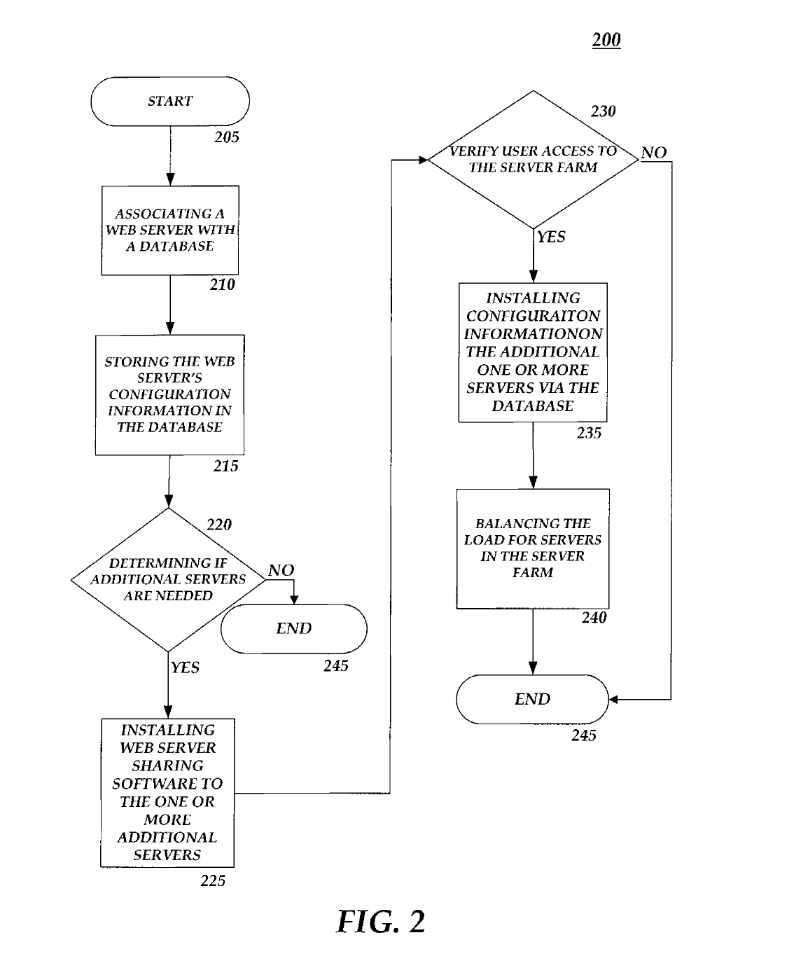

FIG. 2 is a flow chart setting forth the general stages involved in a method 200 consistent with an embodiment of the invention for deploying configuration information within a server farm using a computing device of FIG. 1. Ways to implement the stages of method 200 will be described in greater detail below. Method 200 may begin at starting block 205 and proceed to stage 210 where the server 102 associates a web server, for example, web server 127, to the database 106 via network 110. For example, the web server 127 may be configured to manage web traffic associated with one or more websites. Next at stage 215, the database 106 copies and stores configuration information from the web server 127. The database 106 maintains the configuration information for use in managing the server farm 125. Next, at stage 220, based on data traffic associated with websites served by the server farm 125, determination of whether additional web servers are needed to support the current data traffic is conducted by, for example, a lab technician/web administrator. If the additional servers are not required to support the current data traffic of the server farm 125, the method 200 proceeds to stage 240 where the method 200 ends.

If additional servers are required to support the current data traffic, at stage 225, the lab technician/web administrator may install software on an additional server, for example, new server 130, for connecting the new server 130 to the server farm 125. For example, the software may be installed over the Internet. The software may use a wizard to provide instructions to the lab technician/web administrator for installing the software. The software may be software that allows servers, or other computing devices to share resources when running one or more applications, for example, WINDOWS SHAREPOINT SERVICES created by the Microsoft Corporation of Redmond, Wash. At stage 230, when anyone attempts to add servers, for example, new server 130, to the server farm 125, the server 102 determines whether an individual is authorized to alter the server farm 125 by adding the new server 130. The server 102 may utilize a login and password, or any other authentication process to verify that the individual is authorized to alter the server farm 125. If the individual is not authorized to alter the server farm 125, the method proceeds to stage 240 where the method 200 ends.

If the individual is authorized to alter the server farm 125, at stage 235, the server 102 installs the configuration information stored in database 106 on the new server 130. For example, the installed configuration information may be stored in a local cache in the new server 130. Accordingly, the new server 130 contains the same configuration information as the web server 127 allowing both servers to manage data traffic from the supported website in the same fashion. Furthermore, any server in the server farm 125 can perform any task associated with web content and services because the servers in the server farm 125 can perform the task in the same manner. At stage 240, the server 102 performs load balancing for the web servers in the server farm 125 to maintain equal or near equal management of the supported websites by the web servers in the server farm 125. Accordingly, the load balancing ensures that some web servers are not over taxed while other web servers remain idle when provisioning websites and web services supported by the server farm 125. Exemplary web services may include an Internet Information Service by Microsoft Corporation, user defined web services, or the like. At stage 245, the method 200 ends.

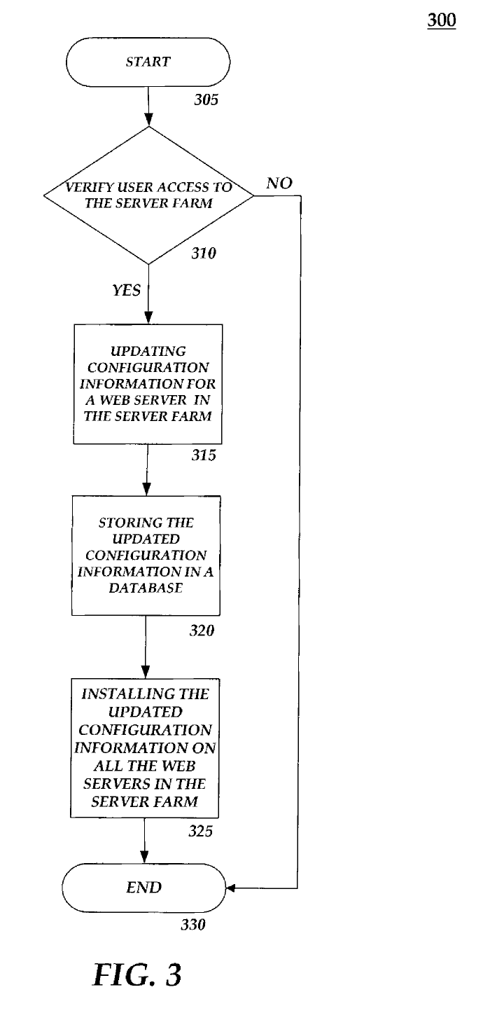

FIG. 3 is a flow chart setting forth the general stages involved in a method 300 consistent with an embodiment of the invention for deploying configuration information within a server farm using a computing device of FIG. 1. The method 300 may be used to provision software updates and alterations to existing configuration information or any other software used by the server farm 125. Method 300 may begin at starting block 305 and proceed to stage 310 where the server 102 determines whether an individual is authorized to alter the server farm 125. The server 102 may utilize a login and password, or any other authentication process to verify that the individual is authorized to alter the server farm 125. If the individual is not authorized to alter the server farm 125, the method proceeds to stage 330 where the method 300 ends.

If the individual is authorized to alter the server farm 125, at stage 315, the individual, for example, a lab technician or web administrator, may update configuration information for a web server in the server farm 125, for example, the web server 127. At stage 320, the server 102 stores the updated configuration information of the web server 127 in database 106. At stage 325, the server 102 installs the updated configuration information stored in database 106 on all the servers in the server farm 125. Accordingly, all the servers in the server farm 125 contain the same configuration information as the web server 127. At stage 330, the method 300 ends.

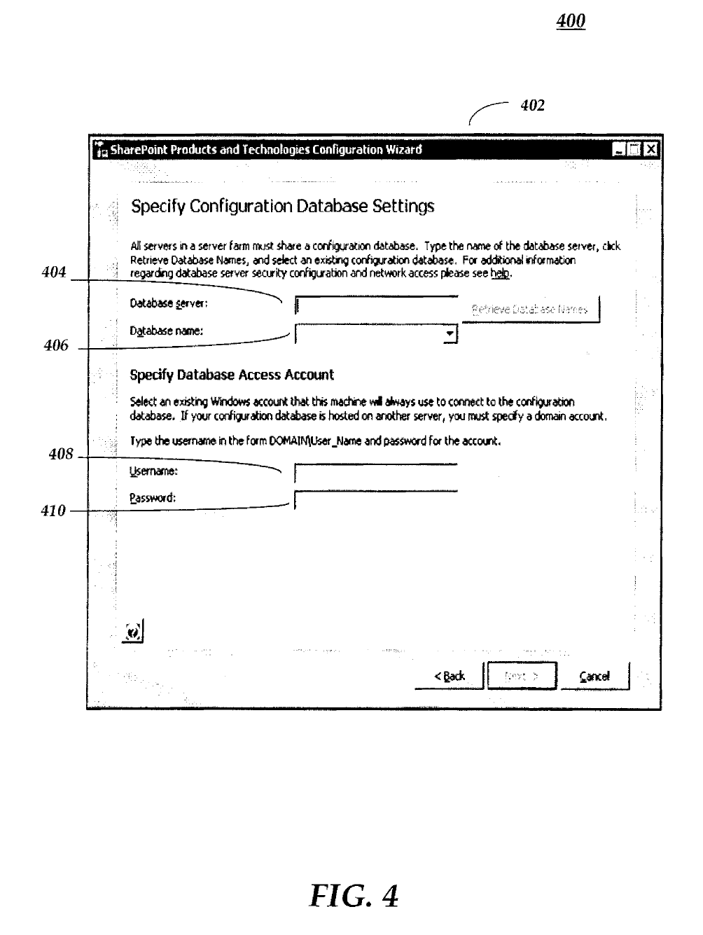

FIG. 4 is an exemplary user interface 400 consistent with an embodiment of the invention for deploying configuration information within a server farm using a computing device of FIG. 1. A technician or web administrator may manage server farm 125 using wizard 402. Managing the server farm 125 may include, for example, incorporating one or more additional servers, for example, new server 130, into the server farm 125, and updating servers within the server farm 125. In entry space 404, the technician/administrator may enter database server information specifying a desired database server, for example, server 102. The database server may control multiple databases, for example, database 106, used in managing the server farm 125. In entry space 406, the technician/administrator may specify a database containing desired configuration information. Accordingly, the technician/administrator may obtain, add or update configuration information for a server farm through the associated database.

In order to maintain server farm integrity and prevent un-authorized access to the server farm 125, security access information may be required to be input by an individual attempting to access the server farm 125. In entry space 408 and 410, the individual or another user may enter username and password information. If the individual enters proper username and password information, the individual may access the database server, the database and the server farm. Accordingly, the database server may implement one or more stages of method 200 and method 300 in response to entry of the proper username and password. If username and password information is improperly input, access to database server, the database and the server farm is denied.

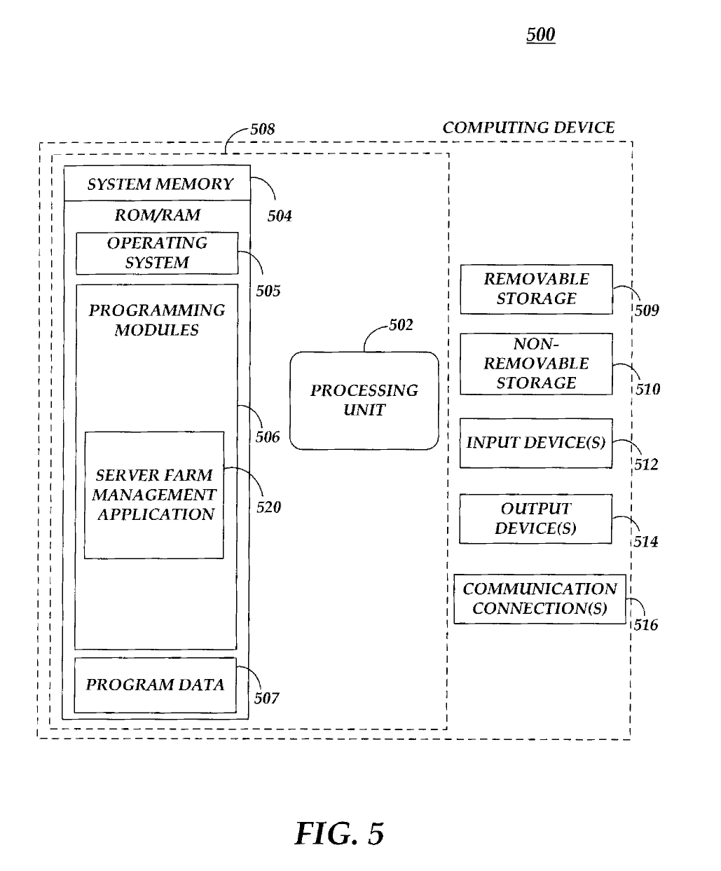

FIG. 5 is a block diagram of a system including a computing device 500, which may be used in conjunction with server 102, desktop computer 112, laptop computer 114 and servers in the server farm 125. Consistent with an embodiment of the invention, any suitable combination of hardware, software, or firmware may be used to implement a memory storage and processing unit. For example, the memory storage and processing unit may be implemented with the computing device 500 or any of the other computing devices in combination with the computing device 500. The aforementioned system, device, and processors are examples and other systems, devices, and processors may comprise the aforementioned memory storage and processing unit, consistent with embodiments of the invention. Furthermore, the computing device 500 may comprise an operating environment for an associated system. The system may operate in other environments and is not limited to computing device 500.

With reference to FIG. 5, a system consistent with an embodiment of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500's operation. In one embodiment, programming modules 506 may include a document creation application for creating and editing a document. Programming modules 506 may include a server farm management application 520 for managing, adding and updating servers in a server farm. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e. memory storage.) Computer storage media may include, but is not limited to, RAM, ROM, electrically erasable read-only memory {EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also employ input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices, such as over network 110 in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 may perform processes including, for example, one or more method stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as show in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for deploying configuration information within a server farm, the method comprising:
associating (210) a first server with a data storage component;
storing (215) configuration information associated with the first server on the data storage component; and
associating (235) one or more servers with the first server and the data storage component by automatically configuring the one or more servers using the stored configuration information, wherein the first server and the one or more servers form the server farm.

2. The method of claim 1 further comprising automatically provisioning web sites and web services associated with the server farm using the stored configuration information.

3. The method of claim 2, wherein a web service is an Internet Information Service.

4. The method of claim 2, wherein a web service is a user defined web service.

5. The method of claim 1 further comprising determining whether additional servers should be added to the server farm based on data traffic associated with the server farm.

6. The method of claim 1 further comprising verifying whether a user can access the server farm.

7. The method of claim 1 further comprising balancing data traffic loads between servers in the server farm.

8. The method of claim 1 further comprising updating configuration information associated with the server farm.

9. A system for deploying configuration information within a server farm, the system comprising:
a memory storage (504, 509, 510), wherein the memory storage stores configuration information for a server farm;
a processing unit (502) coupled to the memory storage, wherein the processing unit is operative to:
associate a plurality of servers with the memory storage, wherein the plurality of servers form a server farm;
store configuration information associated with the plurality of servers on the memory storage;
receive configuration information changes associated with at least one server in the server farm;
update the memory storage with the changed configuration information; and
automatically update the plurality of servers with the changed configuration information.

10. The system of claim 9, wherein the memory storage is a database.

11. The system of claim 9, wherein the configuration information for each of the plurality of servers is stored in a local cache.

12. The system of claim 9 further comprising automatically provisioning web sites and web services associated with the server farm using the stored configuration information.

13. A computer-readable medium (520) which stores a set of instructions which when executed performs a method for deploying configuration information within a server farm, the method executed by the set of instructions comprising:
associating (210) a first server with a database;
storing (215) configuration information associated with the first server on the database; and
automatically configuring (235) the one or more servers using the stored configuration information, wherein the first server and the one or more servers form the server farm and manage data traffic.

14. The computer-readable medium of claim 13 further comprising installing software for receiving the stored configuration information on the one or more servers.

15. The computer-readable medium of claim 14, wherein the software is installed using the Internet.

16. The computer-readable medium of claim 15, wherein the software uses a wizard for the installing of the software.

17. The computer-readable medium of claim 13 further comprising automatically provisioning web sites and web services associated with the server farm using the stored configuration information.

18. The computer-readable medium of claim 13 further comprising balancing data traffic loads between servers in the server farm.

19. The computer-readable medium of claim 13 further comprising determining whether additional servers should be added to the server farm based on data traffic associated with the server farm.

20. The computer-readable medium of claim 13, wherein the configuration information for the first server and the one or more servers is stored in a local cache for each of the first server and the one or more servers.
